(19) United States
(12) Patent Application Publication
(10) Pub. No.: US 2022/0178510 A1
(43) Pub. Date: Jun. 9, 2022

(54) MULTIFUNCTIONAL LIGHTING SYSTEM

(71) Applicant: ams OSRAM Automotive Lighting Systems USA Inc., Troy, MI (US)

(72) Inventor: Adam L. BUSHRE, Saranac, MI (US)

(73) Assignee: ams OSRAM Automotive Lighting Systems USA Inc., Troy, MI (US)

(21) Appl. No.: 17/112,477

(22) Filed: Dec. 4, 2020

(51) Int. Cl. F21S 41/275; F21S 45/48; B60Q 1/08

(52) U.S. Cl. CPC F21S 41/275; B60Q 1/08; F21S 45/48

(57) ABSTRACT

A lighting assembly is provided with a housing defining a cavity with a rearward opening and a forward opening formed opposite the rearward opening along a longitudinal axis. A plurality of light sources is supported by the housing and disposed within the rearward opening. A first lens is supported by the housing with a plurality of optics each aligned with one of the plurality of light sources to receive light and collimate the received light within the housing, wherein the first lens is formed of glass. A second lens is disposed within the forward opening of the housing to receive the collimated light and generate an illumination pattern.

### TECHNICAL FIELD

One or more embodiments relate to a lighting system to generate a multifunctional illumination pattern in front of a vehicle.

### BACKGROUND

Vehicles include lighting systems with one or more headlights that illuminate a region in front of the vehicle. Conventional headlight systems include two illumination modules or assemblies, a high-beam assembly and a low-beam assembly. The high-beam assembly projects light that illuminates a region above a visual horizon and is typically only utilized during conditions of significantly low visibility (e.g., at night on an unlit road). The low-beam assembly projects light that illuminates a region below the visual horizon and is typically used during normal low light conditions (e.g., at night on a lit road).

### SUMMARY

In one embodiment, a lighting module or assembly is provided with a housing defining a cavity with a rearward opening and a forward opening formed opposite the rearward opening along a longitudinal axis. A plurality of light sources is supported by the housing and disposed within the rearward opening. A first lens is supported by the housing with a plurality of optics, each optic is aligned with one of the plurality of light sources to collimate light from the aligned light source within the housing, wherein the first lens is formed of glass. A second lens is disposed within the forward opening of the housing to receive the collimated light and generate an illumination pattern.

Implementations may include one or more of the following features. For instance, the first lens may include a base with a forward side and a rearward side, where the rearward side disposed over and spaced longitudinally apart from the plurality of light sources, wherein the plurality of optics each extend from the forward side of the base. Further, the rearward side of the base may form an input for the plurality of optics. Further, each optic of the plurality of optics may be axially aligned with one of the plurality of light sources. The first lens may be formed of at least one of a borosilicate glass, a soda-lime glass, and a crystal glass to accommodate prolonged exposure to ultraviolet light.

As another example, the second lens may include an input surface longitudinally spaced apart from the first lens at a first length to receive the collimated light; and an output surface to project the received collimated light at a second length to form the illumination pattern. The second lens may include a series of vertically extending segments that extend from the output surface to smooth out the illumination pattern. Further, the second lens may be formed of a polymer.

In certain embodiments, the housing includes a rearward face that defines the rearward opening, and the lighting assembly includes a heat sink with a plate having a forward side mounted to the rearward face of the housing and a plurality of fins extending from a rearward side of the plate.

As another example, the lighting assembly may include a controller that is configured to: receive input indicative of at least one of an external environment and vehicle controls; select a high-beam mode or a low-beam mode based on the input; and activate at least one of the plurality of light sources to generate the illumination pattern based on the selected mode. Further, the controller may be further configured to: select, in addition to the selected high-beam mode or low-beam mode, at least one of a turning mode, a glare-free mode, an object illumination mode, a speed-intensity control mode, and a direction assistance mode based on the input; and activate at least one of a plurality of light sources to generate the illumination pattern based on the selected modes.

A lighting system may include first and second lighting assemblies to mount to a front left portion of a vehicle and to a front right portion of the vehicle, wherein the first lighting assembly and the second lighting assembly collectively provide the illumination pattern.

In another embodiment, a lighting assembly is provided with a housing defining a cavity with a rearward opening and a forward opening formed opposite the rearward opening along a longitudinal axis. A plurality of light sources is supported by the housing and disposed within the rearward opening. A first lens is supported by the housing with a plurality of optics, each optic is aligned with one of the plurality of light sources to collimate light from the aligned light source within the housing, wherein the first lens is formed of glass. A second lens is disposed within the forward opening of the housing to receive the collimated light and generate an illumination pattern. A processor is programmed to: receive input indicative of at least one of an external environment and vehicle controls; select a high-beam mode or a low-beam based on the input; and activate at least one of the plurality of light sources to generate the illumination pattern based on the selected mode.

Implementations may include one or more of the following features. For instance, The first lens may include a base with a forward side and a rearward side, the rearward side disposed over and spaced longitudinally apart from the plurality of light sources; and wherein the plurality of optics each extend from the forward side of the base. Further, the rearward side of the base forms an input for the plurality of optics. The second lens may include an input surface longitudinally spaced apart from the first lens at a first focal length to receive the collimated light; and an output surface to project the received collimated light at a second focal length to form the illumination pattern. Further, the second lens may include a series of vertically extending segments that extend from the output surface to smooth out the illumination pattern.

In certain embodiments, the housing includes a rearward face that defines the rearward opening, and the lighting assembly further includes a heat sink with a plate having a forward side mounted to the rearward face of the housing and a plurality of fins extending from a rearward side of the plate.

In yet another embodiment, a method for illumination is provided. Input is received that is indicative of at least one of an external environment and vehicle controls. At least one mode is selected based on the input, wherein the at least one mode includes a high-beam mode or a low-beam mode. At least one of a plurality of light sources in a light assembly is activated to generate light through a plurality of axially aligned collimators, and then through another lens to project the collimated light to generate an illumination pattern based on the selected mode.

Implementations may include one or more of the following features. For instance, in addition to the selected high-beam mode or low-beam mode, at least one of a turning mode, a glare-free mode, an object illumination mode, a direction assistance mode, a speed-intensity control mode, an on-road mode, and an off-road mode is selected. Further, at least one of a plurality of light sources is activated to generate the illumination pattern based on the selected modes.

### BRIEF DESCRIPTION OF THE DRAWINGS

FIG. 1 is a top schematic view of a vehicle having a lighting system, including two light assemblies, to generate a multifunctional illumination pattern according to one or more embodiments.

FIG. 1A is an enlarged view of one of the light assemblies of FIG. 1.

FIG. 2 is an exploded view of one of the light assemblies of FIG. 1.

FIG. 3 is a fragmented front view of the light assembly of FIG. 2, illustrating a first lens and a second lens.

FIG. 4 is a schematic diagram illustrating a top view of the lighting system of FIG. 1.

FIG. 4A is an enlarged view of a portion of the first lens of FIG. 4.

FIG. 4B is an enlarged view of a portion of the second lens of FIG. 4.

FIG. 5 is a schematic diagram illustrating a side view of the lighting system of FIG. 1.

FIG. 6 is a diagram illustrating an illumination pattern overlaid on a grid.

FIG. 7 is a flow chart illustrating a method for generating a multifunctional illumination pattern.

FIG. 8 illustrates a low-beam off-road illumination pattern.

FIG. 9 illustrates a low-beam on-road illumination pattern.

FIG. 10 illustrates a high-beam off-road illumination pattern.

FIG. 11 illustrates a high-beam off-road low-turning angle illumination pattern.

FIG. 12 illustrates a high-beam off-road medium-turning angle illumination pattern.

FIG. 13 illustrates a high-beam off-road high-turning angle illumination pattern.

FIG. 14 illustrates a high-beam off-road glare-free illumination pattern.

FIG. 15 illustrates the high-beam off-road glare-free illumination pattern of FIG. 14 implemented in a three-dimensional (3D) environment.

FIG. 16 illustrates a high-beam off-road object illumination pattern.

FIG. 17 illustrates the high-beam off-road object illumination pattern of FIG. 16 implemented in a 3D environment.

FIG. 18 illustrates a high-beam off-road direction assistance illumination pattern.

FIG. 19 illustrates the high-beam off-road direction assistance illumination pattern of FIG. 18 implemented in a 3D environment.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis.

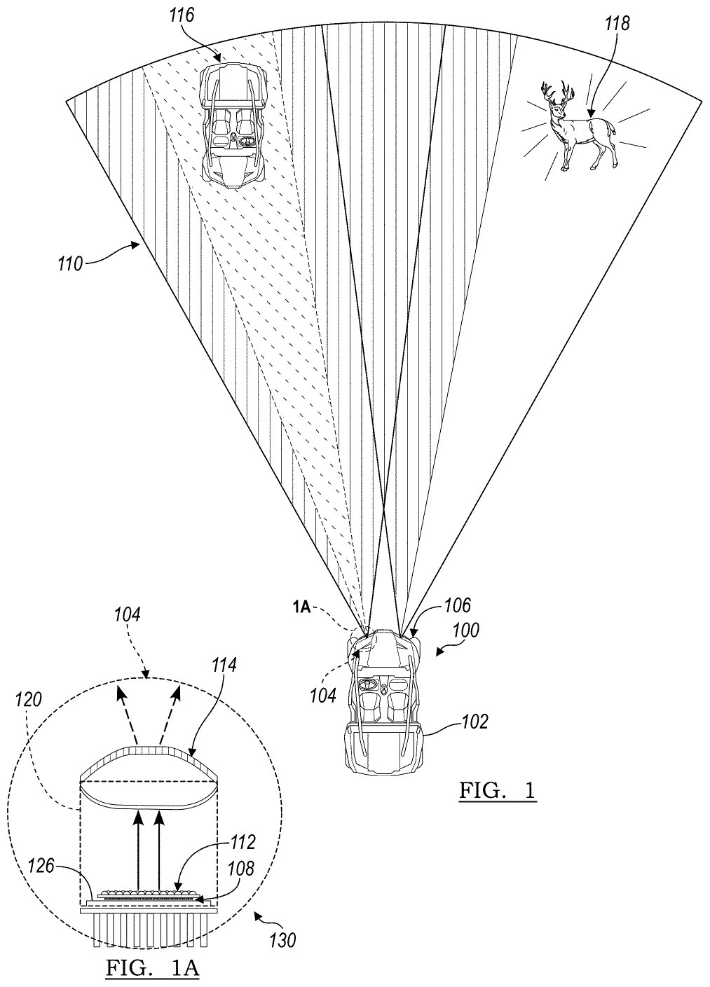

With reference to FIG. 1, a lighting system is illustrated in accordance with one or more embodiments and is generally illustrated by numeral 100. The lighting system 100 is contained within a vehicle 102 and includes two light assemblies, a left light assembly 104 and a right light assembly 106. The light assemblies 104, 106 are mounted to the front of the vehicle 102 to provide forward lighting. Each lighting assembly 104, 106 includes a plurality of light sources 108 that are individually controlled to provide an illumination pattern 110. Each lighting assembly 104, 106 also includes a first lens 112 and a second lens 114 that adjust the light output from the light sources 108 to form the illumination pattern 110.

The lighting system 100 provides an illumination pattern 110 that includes one or more modes, e.g., high-beam, low-beam, turning, glare-free, object illumination, speed intensity control, and direction assistance, in either an on-road or off-road environment. FIG. 1 illustrates an illumination pattern 110 that includes high-beam, glare-free and object illumination functionality in an off-road environment. The high-beam light is represented by a cross-hatched region in FIG. 1. The lighting system 100 detects an oncoming vehicle 116 and turns off certain light sources 108 that would otherwise project light directly at the oncoming vehicle 116 to provide glare-free functionality, as represented by a shaded region. The lighting system 100 also detects an object 118, i.e., an approaching deer, and increases the intensity of certain light sources 108 that project light at the deer 118 to provide object illumination functionality, as represented by the unshaded region. The lighting system 100 updates or adapts the illumination pattern 110 as conditions change, e.g., the lighting system 100 may turn on/off different light sources 108 as the positions of the oncoming vehicle 116 and/or the animal 118 change relative to the vehicle 102 position.

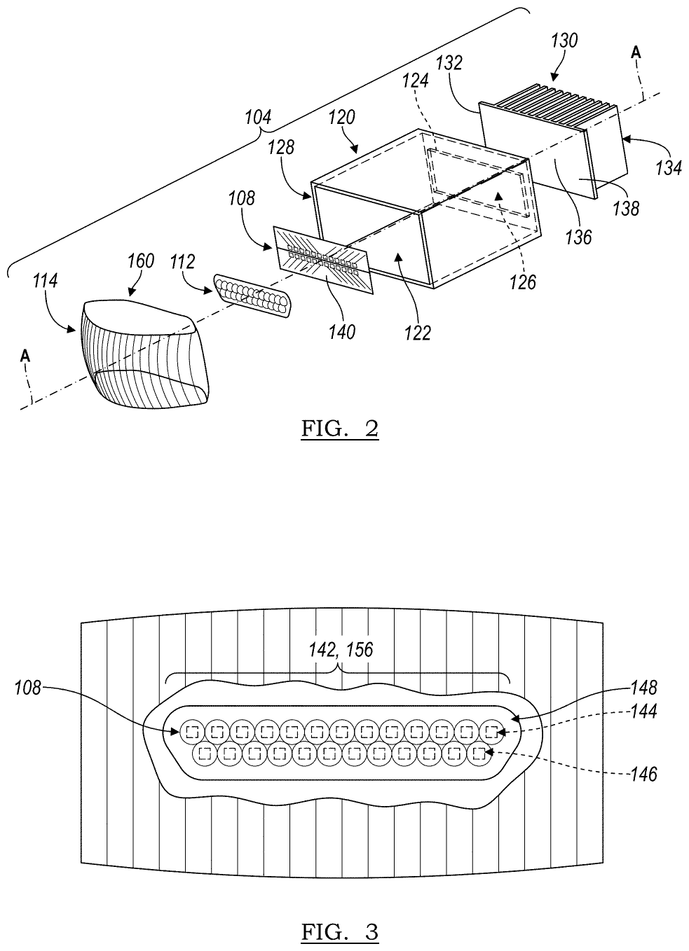

Referring to FIG. 2, each light assembly 104, 106 includes a single compact assembly that provides multiple modes. The left light assembly 104 includes a housing 120 that is mounted to a front-left portion of the vehicle 102 (FIG. 1). The housing 120 defines a cavity 122 and includes a rearward face 124 that defines a rearward opening 126. The housing 120 forms a forward opening 128 that is oriented opposite the rearward face 124 along a longitudinal axis A-A. In one embodiment, the housing 120 is formed in a rectangular prism shape.

The left light assembly 104 includes a heat sink 130 for dissipating heat generated by the light sources 108 during operation. The heat sink 130 includes a plate 132 and a plurality of fins 134 that extend transversely from a rearward side of the plate 132. The plate 132 includes a forward surface with a central portion 136 and a peripheral portion 138. The light sources 108 are mounted to a substrate 140 that is mounted to the central portion 136 of the plate 132 (FIG. 1). Heat generated by the light sources 108 is transferred by conduction through the substrate 140 to the plate 132 and on to the fins 134. The peripheral portion 138 of the plate 132 is mounted to the rearward face 124 of the housing 120 such that the light sources 108 are disposed within the rearward opening 126.

The first lens 112 is mounted to the substrate 140 and disposed over the light sources 108. The second lens 114 is mounted to the housing 120 about the forward opening 128. The left and right light assemblies 104, 106 include identical components according to one or more embodiments, and the description of the left light assembly 104 is applicable to the right light assembly 106. In other embodiments, the right light assembly 106 includes components that are generally mirror images of the components of the left light assembly 104.

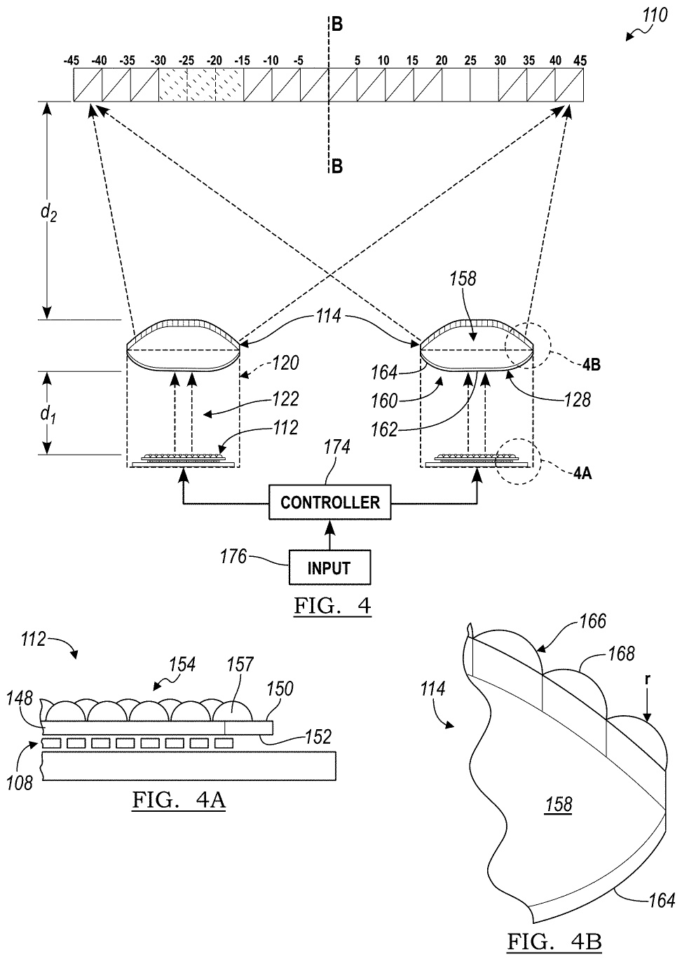

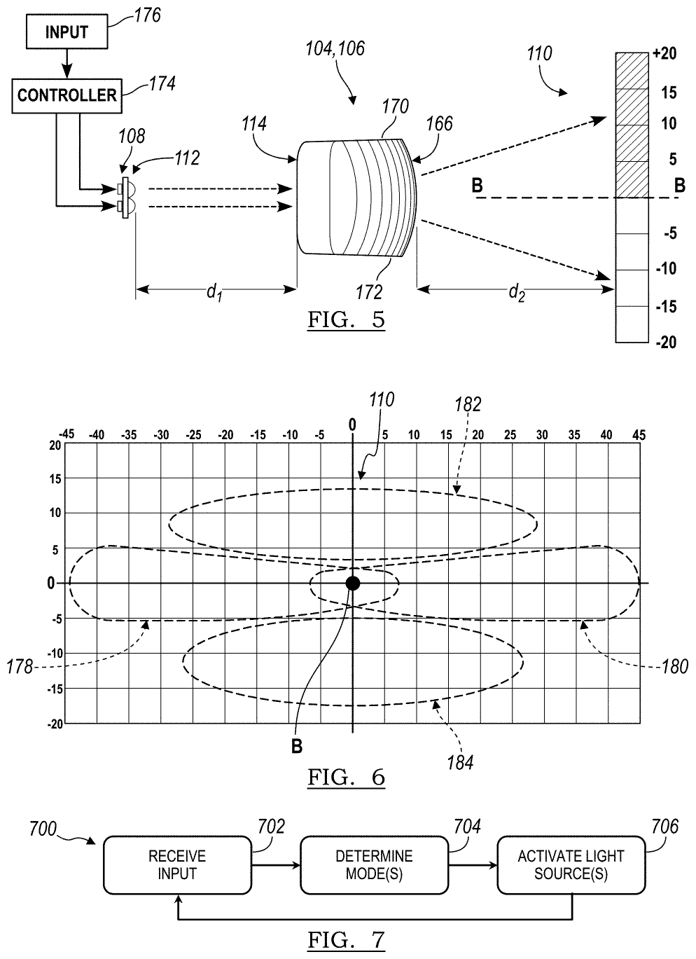

With reference to FIG. 3, the light sources 108 may be arranged in a matrix 142. In the illustrated embodiment, the matrix 142 includes twenty-five light sources 108 that are arranged two rows: an upper row 144 and a lower row 146. The rows 144, 146 are staggered laterally relative to each other to provide a staggered matrix 142, however the light sources 108 are spaced apart from each other, as compared to multi-chip or close proximity LEDs designs, to spread the heat uniformly which allows for less complex heat sink options, e.g., the heat sink 130 illustrated in FIG. 2 includes generally simple planar shaped components. The staggered matrix 142 is formed in a generally rectangular configuration, with an elongate width to provide wide lateral dispersion (shown in FIG. 4), and a compact vertical height to provide a compact vertical dispersion (shown in FIG. 5). The light sources 108 may be semiconductor light sources, such as light emitting diodes (LEDs), laser diodes, or organic light emitting diodes (OLEDs). In one embodiment the light sources 108 are OSLON compact PL LEDs by Osram Opto Semiconductors.

Referring to FIGS. 4-4B, the first lens 112 collimates the light output from the light sources 108 within the cavity 122 of the housing 120. The first lens 112 includes a base 148 with a forward side 150 and a rearward side 152. The rearward side 152 is disposed over the light sources 108 to receive the light output. The first lens 112 is mounted proximate to the light sources 108 to maximize the received light, e.g., the longitudinal distance between the rearward side 152 and a top surface of each light source 108 may be less than one millimeter. The first lens 112 is exposed to intense ultraviolet light over prolonged periods of time, due to its close proximity to the light sources 108. Therefore, the first lens 112 is formed of glass or of a polymer rated to accommodate prolonged exposure to such ultraviolet light without degradation. For example, the first lens 112 may be formed of a borosilicate glass, a soda-lime glass, or a crystal glass.

The first lens 112 also includes a plurality of optics 154 that extend from the forward side 150 of the base 148. The plurality of optics 154 may be arranged in a staggered lens matrix 156 that corresponds to the staggered light source matrix 142, such that each optic 154 is aligned with one of the light sources 108 along an axis (not shown). Each optic 154 may have a small outer diameter, e.g., less than five mm, that corresponds to the dimensions of the light sources 108. The optics 154 may be integrally formed with the base 148 such that the rearward side 152 of the base 148 forms a planar input surface for all of the optics 154. Each optic 154 is formed with an output surface 157 having a freeform, semi-spherical shape, that extends from the forward side 150 of the base 148 to focus the received collimated light within the cavity 122 at a focal point. A freeform shape refers to a continuously changing surface with no segmentation.

The second lens 114 projects the light output from the first lens 112 to provide the illumination pattern 110. The second lens 114 includes a body 158 that is formed in a complex continuously changing freeform shape and disposed within the forward opening 128 of the housing 120. The second lens 114 may be formed of a polymer, e.g., acrylic or polycarbonate. The body 158 includes an input surface 160 with a central region 162 and outer regions 164. The input surface 160 is longitudinally spaced apart from the first lens 112 to receive the collimated light output from the first lens 112.

The body 158 of the second lens 114 also includes an output surface 166 having a freeform semi-spherical shape to project the light in front of the vehicle 102 to form the illumination pattern 110. The freeform shapes of the first lens 112 and the second lens 114 allow the lighting assembly to provide both low-beam and high-beam functionality in a single assembly. High light collection from the first lens 112 and efficient distribution of the light from the second lens 114 lowers the needed power requirement of the light sources 108.

Each optic 154 of the first lens 112 collimates light received from the corresponding light source 108 at a focal point. The distance between each focal point and the first lens 112 is represented by a first length (d₁), which is similar to a focal length. The central region 162 of the second lens 114 is arranged at the first length (d₁) to receive the collimated light. The second lens 114 projects light received from the first lens 112 at a second length (d₂) in front of the vehicle 102 to form the illumination pattern 110, which is a far-field image. The shape and intensity of the illumination pattern may be standardized, for example SAE J1623, ROHVA/ANSI-1, FMVSS108, and CMVSS108 provide standards and regulations for vehicle illumination patterns.

FIG. 4 illustrates how the left light assembly 104 and the right light assembly 106 disperse light laterally in front of the vehicle 102 to form the illumination pattern 110. In one or more embodiments, each light assembly 104, 106 is designed to provide the full illumination pattern 110 alone, which allows the light assemblies 104, 106 to operate under lower power to collectively provide the illumination pattern 110, and for lighting systems 100 that include one light assembly 104, e.g., a snowmobile or motorcycle. The illumination pattern 110 may be separated into blocks representing a distance from a central optical axis (Axis B-B) at five-degree increments, as shown in FIG. 4. The output surface 166 of each light assembly 104, 106 is formed in an arcuate shape laterally to disperse light laterally as depicted by dashed lines.

The lighting system 100 includes a controller 174 that individually controls each light source 108. The controller 174 receives input 176 that is indicative of the environment in front of the vehicle and/or vehicle controls. The input 176 may be generated by sensors or received from an external source. For example, the vehicle 102, or the lighting system 100 itself, may include sensors, e.g., cameras or Lidar, Radar, or Infrared sensors, that can detect external objects or conditions, e.g., road gradient, road curvature, oncoming traffic, animals, signs, ambient light, etc. The vehicle 102 may also include sensors that detect internal vehicle operating conditions, e.g., steering wheel angle, speed, etc. The vehicle 102 may also include systems or controllers that communicate with other systems to detect external conditions, e.g., a navigation system.

The controller 174 analyzes the input 176 and selects one or more modes, e.g., glare-free, and object illumination, and controls corresponding light sources 108 to provide the corresponding illumination pattern 110. For example, the controller 174 may receive input indicative of an oncoming vehicle 116 (FIG. 1) within a region between −15 degree and −30 degrees, and turn off the corresponding light sources 108 that would project light in this region, as represented by the shaded blocks in FIG. 4. The controller 174 may also receive input indicative of an object, such as a sign, or animal 118 (FIG. 1) in a region between 20 degrees and 30 degrees, and increase the intensity of the light sources 108 that project light in this region, as represented by the unshaded blocks in FIG. 4.

With reference to FIGS. 4A-4B, the light generated by different light sources 108 may interact and blur or become distorted, which is called an aberration or a picket fence effect. The second lens 114 includes a series of vertically extending composite compact segments 168 that extend outward from the output surface 166 to smooth out the illumination pattern 110. The series of segments 168 extend vertically between an upper surface 170 (FIG. 5) and a lower surface 172 of the body 158. The series of segments 168 may be formed with a common lateral width, e.g., 3-5 mm, and different radii (r). Each segment 168 optimizes compactness with a short focal length and minimal lens thickness to smooth out the illumination pattern by blurring the edges of the sharp images of the light sources 108 that are projected into the far field. Further, by incorporating the series of segments 168 into the second lens 114, the lighting system 100 provides edge-blending functionality without adding additional optical components or lenses.

FIG. 5 is a side view of the lighting system 100 and illustrates how the left light assembly 104 and the right light assembly 106 disperse light vertically in front of the vehicle 102 to form the illumination pattern 110. The illumination pattern 110 may be separated into blocks representing a vertical distance from the optical axis B-B, at five-degree increments, as shown in FIG. 5. The output surface 166 of each light assembly 104, 106 is formed in an arcuate shape vertically to disperse light as depicted by dashed lines.

The controller 174 analyzes the input 176 and selects one or more modes, e.g., high-beam, and low-beam, and controls corresponding light sources 108 to provide the corresponding illumination pattern 110. For example, the controller 174 may receive input indicative of sufficient ambient lighting (e.g., daylight) external to the vehicle 102 and turn off a high-beam mode by reducing the intensity of the light sources 108 that would project light above the optical axis B-B, as represented by the partially shaded blocks above zero in FIG. 5.

FIG. 6 is a diagram illustrating a general representation of the illumination pattern 110 overlaid on a grid representing the range of the lighting system 100. The illumination pattern 110 includes two central regions: a left central region 178 and a right central region 180, that both extend laterally from the optical axis B-B. The illumination pattern 110 also includes an upper region 182 and a lower region 184 above and below the central regions 178, 180, respectively.

With reference to FIG. 7, a method for generating a multifunctional illumination pattern is illustrated in accordance with one or more embodiments and generally referenced by numeral 700. The method 700 is implemented using software code contained within the controller 174 according to one or more embodiments. While the method is described using flowcharts that are illustrated with a number of sequential steps, one or more steps may be omitted and/or executed in another manner in one or more other embodiments. In other embodiments, the software code is distributed among multiple controllers, e.g., the controller 174 and one or more vehicle controllers (not shown).

Although the controller 174 is shown as a single controller, it may contain multiple controllers, or may be embodied as software code within one or more other controllers. The controller 174 generally includes any number of microprocessors, ASICs, ICs, memory (e.g., FLASH, ROM, RAM, EPROM and/or EEPROM) and software code to co-act with one another to perform a series of operations. Such hardware and/or software may be grouped together in assemblies to perform certain functions. Any one or more of the controllers or devices described herein include computer executable instructions that may be compiled or interpreted from computer programs created using a variety of programming languages and/or technologies. In general, a processor (such as a microprocessor) receives instructions, for example from a memory, a computer-readable medium, or the like, and executes the instructions. A processing unit includes a non-transitory computer-readable storage medium capable of executing instructions of a software program. The computer readable storage medium may be, but is not limited to, an electronic storage device, a magnetic storage device, an optical storage device, an electromagnetic storage device, a semi-conductor storage device, or any suitable combination thereof. The controller 174, also includes predetermined data, or “look up tables” that are stored within memory, according to one or more embodiments.

At step 702, the controller 174 receives input 176 that is indicative of the environment in front of the vehicle and/or vehicle controls, e.g., road gradient, road curvature, other vehicles, animals, signs, ambient light, steering wheel angle, vehicle speed, etc. At step 704, the controller 174 selects one or more modes, e.g., high-beam, low-beam, turning, glare-free, object illumination, speed intensity control, and direction assistance, in either an on-road or off-road environment, based on the input 176. At step 706, the controller 174 activates one or more light sources 108 to provide an illumination pattern 110 that includes the selected mode. The lighting system 100 updates or adapts the illumination pattern 110 as conditions change, e.g., after step 706, the controller 174 returns to step 702 to receive new input.

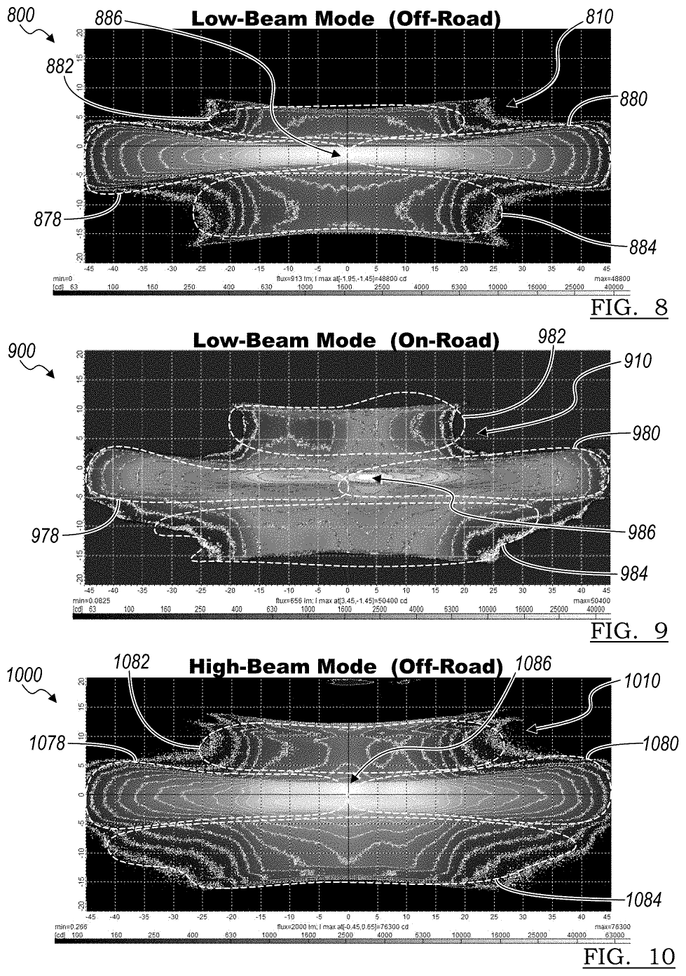

FIGS. 8-19 illustrate the intensity of various far-field illumination patterns by capturing the luminous flux distribution represented on candela distribution graphs. In one or more embodiments, each light assembly 104, 106 is designed to provide the full illumination pattern 110 alone.

FIGS. 8 and 9 illustrate a comparison of the illumination patterns between on-road and off-road environments. FIG. 8 is a graph 800 illustrating an illumination pattern 810 generated by the lighting system 100 that includes low-beam functionality in an off-road environment, and FIG. 9 is a graph 900 illustrating an illumination pattern 910 generated by the lighting system 100 that includes low-beam functionality in an on-road environment. The low-beam off-road illumination pattern 810, includes a left central region 878, a right central region 880, an upper region 882, and a lower region 884. The low-beam on-road illumination pattern 910, also includes a left central region 978, a right central region 980, an upper region 982, and a lower region 984.

The upper region 982 of the low-beam on-road illumination pattern 910 extends farther (i.e., to 10 degrees) than the upper region 882 of the low-beam off-road illumination pattern 810 to account for the higher speeds typically encountered when driving on-road as compared to off-road. The central regions 978, 980 of the low-beam on-road illumination pattern 910 include a high intensity region 986 that is biased to the right of the optical axis B (i.e. around 5 degrees), whereas the central regions 878, 880 of the low-beam off-road illumination pattern 810 include a high intensity region 886 that is centered about the optical axis B (zero degrees), to account for more oncoming traffic typically encountered when driving on-road as compared to off-road.

FIGS. 8 and 10 illustrate a comparison of the illumination patterns between high-beam and low-beam functionality in off-road environments. FIG. 8 illustrates the low-beam off-road illumination pattern 810, and FIG. 10 is a graph 1000 illustrating an illumination pattern 1010 generated by the lighting system 100 that includes high-beam functionality in an off-road environment. The high-beam off-road illumination pattern 1010, includes a left central region 1078, a right central region 1080, an upper region 1082, and a lower region 1084.

The upper region 1082 of the high-beam off-road illumination pattern 1010 extends farther (i.e., to 12 degrees) than the upper region 882 of the low-beam off-road illumination pattern 810 to provide better visibility. The central regions 1078, 1080 of the high-beam off-road illumination pattern 1010 include a high intensity region 1086 that extends further vertically (i.e. between −3 and 3 degrees) as compared to the high intensity region 886 of the low-beam off-road illumination pattern 810 (i.e. between −3 and 0 degrees) to provide better visibility.

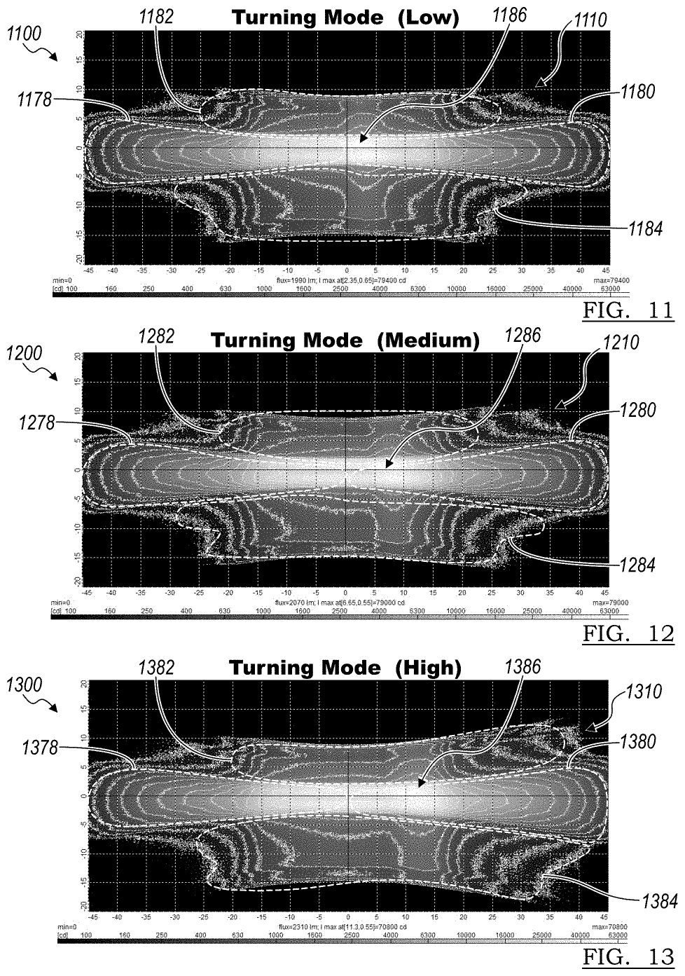

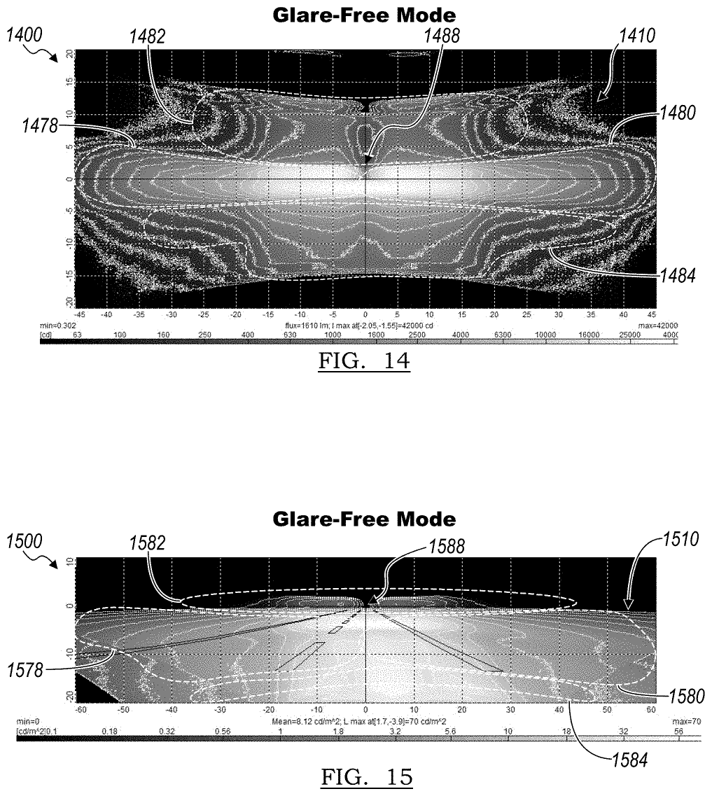

FIGS. 11-13 illustrate the turning functionality of the lighting system 100, whereby the lighting system 100 adjusts the illumination pattern 110 while the vehicle 102 is turning. FIG. 11 is a graph 1100 illustrating an illumination pattern 1110 generated by the lighting system 100 at a low-turning angle (e.g., 5 degrees), FIG. 12 is a graph 1200 illustrating an illumination pattern 1210 generated by the lighting system 100 at a medium-turning angle (e.g., 10 degrees), and FIG. 13 is a graph 1300 illustrating an illumination pattern 1310 generated by the lighting system 100 at a high-turning angle (e.g., 15 degrees).

The high-beam off-road low-turning angle illumination pattern 1110 of FIG. 11, includes a left central region 1178, a right central region 1180, an upper region 1182, and a lower region 1184. The high-beam off-road medium-turning angle illumination pattern 1210 of FIG. 12, includes a left central region 1278, a right central region 1280, an upper region 1282, and a lower region 1284. The high-beam off-road high-turning angle illumination pattern 1310 of FIG. 13, includes a left central region 1378, a right central region 1380, an upper region 1382, and a lower region 1384.

As illustrated in FIGS. 10-13, the lighting system 100 shifts a high intensity region of the illumination pattern laterally based on the steering angle. The high-beam off-road illumination pattern 1010 of FIG. 10 is illustrated with a zero turning angle and the high intensity region 1086 is centrally located at zero degrees. The high-beam off-road low-turning angle illumination pattern 1110 of FIG. 11, includes a high intensity region 1186 within the right central region 1180 that is shifted to approximately 5 degrees. The high-beam off-road medium-turning angle illumination pattern 1210 of FIG. 12, includes a high intensity region 1286 within the right central region 1280 that is shifted to approximately 10 degrees. The high-beam off-road high-turning angle illumination pattern 1310 of FIG. 13, includes a high intensity region 1386 within the right central region 1380 that is shifted to approximately 15 degrees. FIGS. 10-13 illustrate that the lighting system 100 shifts a high intensity region of the illumination pattern further as the steering angle increases. Although the lighting system 100 is illustrated shifting a high intensity region of the illumination pattern laterally based on the steering angle up to 15 degrees, the lighting system 100 may also be implemented in applications with greater turning radius, e.g., up to 20 degrees.

FIGS. 14-15 illustrate the glare-free functionality of the lighting system 100. FIG. 14 is a graph 1400 illustrating an illumination pattern 1410 generated by the lighting system 100 that includes high-beam functionality in an off-road environment. The illumination pattern is generally a two-dimensional (2D) image because it is illustrated at a common second length (d₂) for all projected light. However, the real world is three-dimensional (3D), and FIG. 15 is a graph 1500 illustrating the 2D illumination pattern 1410 of FIG. 14 implemented in a 3D environment.

The 2D high-beam off-road glare-free illumination pattern 1410 of FIG. 14, includes a left central region 1478, a right central region 1480, an upper region 1482, and a lower region 1484. The central regions 1478, 1480 include a glare-free region 1488 at the optical axis (i.e., at approximately zero degrees lateral and zero degrees vertical). The 3D high-beam off-road glare-free illumination pattern 1510 of FIG. 15, includes a left central region 1578, a right central region 1580, an upper region 1582, and a lower region 1584, that correspond to the regions 1478, 1480, 1482, and 1484, respectively of FIG. 14. The central regions 1578, 1580 also include a glare-free region 1588 at the optical axis (i.e., at approximately zero degrees lateral and zero degrees vertical). For example, the controller 174 may receive input 176 of an oncoming vehicle 116 (FIG. 1) at this location and turn off certain light sources 108 that would otherwise project light directly at the oncoming vehicle 116 to provide the glare-free functionality.

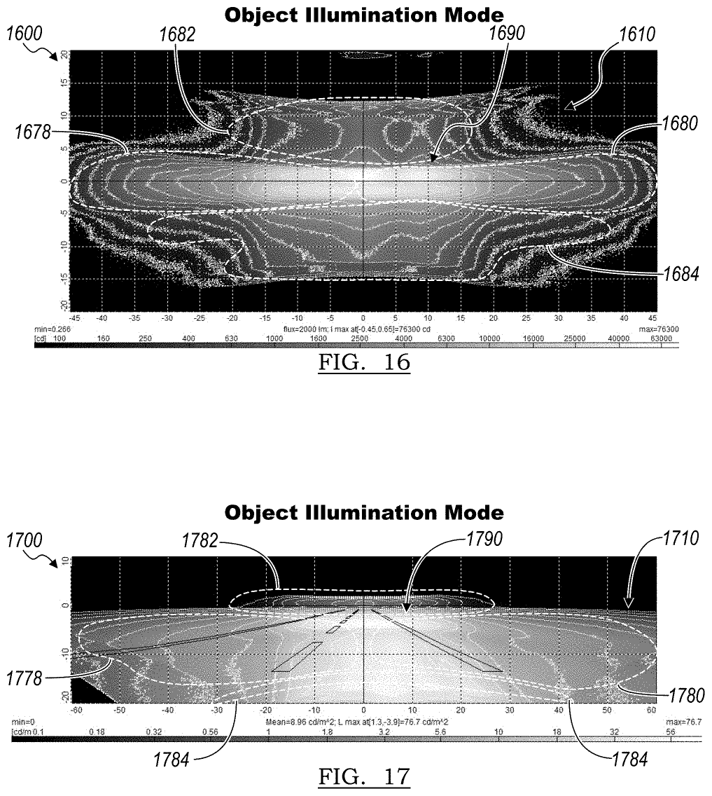

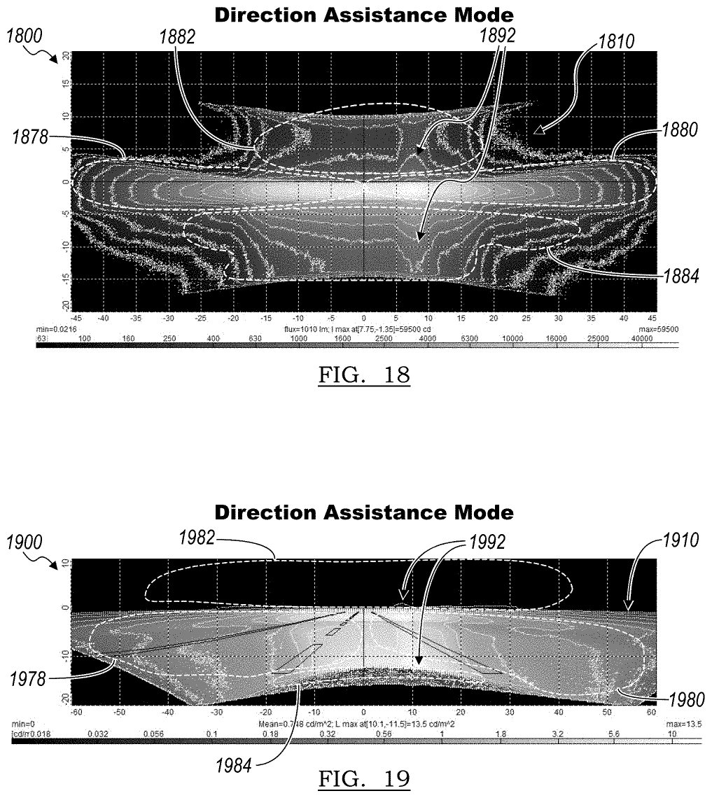

FIGS. 16-17 illustrate the objection illumination functionality of the lighting system 100. FIG. 16 is a graph 1600 illustrating a 2D illumination pattern 1610 generated by the lighting system 100 that includes high-beam functionality in an off-road environment. FIG. 17 is a graph 1700 illustrating the 2D illumination pattern 1610 of FIG. 16 implemented in a 3D environment.

The 2D high-beam off-road object illumination pattern 1610 of FIG. 16 includes a left central region 1678, a right central region 1680, an upper region 1682, and a lower region 1684. The right central region 1680 includes an object illumination region 1690 between 5 and 10 degrees. The 3D high-beam off-road glare-free illumination pattern 1710 of FIG. 17, includes a left central region 1778, a right central region 1780, an upper region 1782, and a lower region 1784, that correspond to the regions 1678, 1680, 1682, and 1684, respectively of FIG. 16. The right central region 1780 also includes an object illumination region 1790 between 5 and 10 degrees. For example, the controller 174 may receive input 176 of an animal 118 on the side of a trail or road (FIG. 1) at this location and increase the intensity of certain light sources 108 that project light at this location to illuminate the object (animal) 118.

FIGS. 18-19 illustrate the direction assistance functionality of the lighting system 100. FIG. 18 is a graph 1800 illustrating a 2D illumination pattern 1810 generated by the lighting system 100 that includes high-beam functionality in an off-road environment. FIG. 19 is a graph 1900 illustrating the 2D illumination pattern 1810 of FIG. 18 implemented in a 3D environment.

The 2D high-beam off-road direction assistance illumination pattern 1810 of FIG. 18 includes a left central region 1878, a right central region 1880, an upper region 1882, and a lower region 1884. The right central region 1880, the upper region 1882, and the lower region 1884 all include a direction assistance region 1892 between 5 and 10 degrees. The 3D high-beam off-road direction assistance illumination pattern 1910 of FIG. 19, includes a left central region 1978, a right central region 1980, an upper region 1982, and a lower region 1984, that correspond to the regions 1878, 1880, 1882, and 1884, respectively of FIG. 18. The right central region 1980, the upper region 1982, and the lower region 1984 also include a direction assistance region 1992 between 5 and 10 degrees that represents a finger pointing in the direction of the upcoming turn. For example, the controller 174 may receive input 176 from a navigation system indication of an upcoming right turn at this location and increase the intensity of certain light sources 108 that project light at this location to illuminate the turn.

Although the lighting system 100 is illustrated with two light assemblies 104, 106, the lighting system 100 may also be implemented with more or less than two light assemblies. For example, a lighting system 100 with a single light assembly 104 may be implemented in a snowmobile or motorcycle (not shown).

While exemplary embodiments are described above, it is not intended that these embodiments describe all possible forms of the present disclosure. Rather, the words used in the specification are words of description rather than limitation, and it is understood that various changes may be made without departing from the spirit and scope of the present disclosure. Additionally, the features of various implementing embodiments may be combined to form further embodiments.

What is claimed is:

1. A lighting assembly comprising:
a housing defining a cavity with a rearward opening and a forward opening formed opposite the rearward opening along a longitudinal axis;
a plurality of light sources supported by the housing and disposed within the rearward opening;
a first lens supported by the housing with a plurality of optics, each optic aligned with one of the plurality of light sources to collimate light from the aligned light source within the housing, wherein the first lens is formed of glass; and
a second lens disposed within the forward opening of the housing to receive the collimated light and generate an illumination pattern.

2. The lighting assembly of claim 1, wherein the first lens further comprises:
a base with a forward side and a rearward side, the rearward side disposed over and spaced longitudinally apart from the plurality of light sources; and
wherein the plurality of optics each extend from the forward side of the base.

3. The lighting assembly of claim 2, wherein the rearward side of the base forms an input for the plurality of optics.

4. The lighting assembly of claim 1, wherein the first lens is formed of at least one of a borosilicate glass, a soda-lime glass, and a crystal glass to accommodate prolonged exposure to ultraviolet light.

5. The lighting assembly of claim 1, wherein the second lens further comprises:
an input surface longitudinally spaced apart from the first lens at a first length to receive the collimated light; and
an output surface to project the received collimated light at a second length to form the illumination pattern.

6. The lighting assembly of claim 5, wherein the second lens includes a series of vertically extending segments that extend from the output surface to smooth out the illumination pattern.

7. The lighting assembly of claim 1, wherein the second lens is formed of a polymer.

8. The lighting assembly of claim 1, wherein each optic of the plurality of optics is axially aligned with one of the plurality of light sources.

9. The lighting assembly of claim 1 wherein the housing comprises a rearward face defining the rearward opening, the lighting assembly further comprising:
a heat sink with a plate having a forward side mounted to the rearward face of the housing and a plurality of fins extending from a rearward side of the plate.

10. The lighting assembly of claim 1, further comprising a controller configured to:
receive input indicative of at least one of an external environment and vehicle controls;
select a high-beam mode or a low-beam mode based on the input; and
activate at least one of the plurality of light sources to generate the illumination pattern based on the selected mode.

11. The lighting assembly of claim 10, wherein the controller is further configured to:
select, in addition to the selected high-beam mode or low-beam mode, at least one of a turning mode, a glare-free mode, an object illumination mode, a speed-intensity control mode, and a direction assistance mode based on the input; and
activate at least one of a plurality of light sources to generate the illumination pattern based on the selected modes.

12. A lighting system comprising:
first and second lighting assemblies, each according to claim 1, to mount to a front left portion of a vehicle and to a front right portion of the vehicle, wherein the first lighting assembly and the second lighting assembly collectively provide the illumination pattern.

13. A lighting assembly comprising:
a housing defining a cavity with a rearward opening and a forward opening formed opposite the rearward opening along a longitudinal axis;
a plurality of light sources supported by the housing and disposed within the rearward opening;
a first lens supported by the housing with a plurality of optics, each optic aligned with one of the plurality of light sources to collimate light from the aligned light source within the housing; and
a second lens disposed within the forward opening of the housing to receive the collimated light and generate an illumination pattern;
a processor programmed to:
receive input indicative of at least one of an external environment and vehicle controls;
select a high-beam mode or a low-beam mode based on the input; and
activate at least one of the plurality of light sources to generate the illumination pattern based on the selected mode.

14. The lighting assembly of claim 13, wherein the first lens further comprises:
a base with a forward side and a rearward side, the rearward side disposed over and spaced longitudinally apart from the plurality of light sources; and
wherein the plurality of optics each extend from the forward side of the base.

15. The lighting assembly of claim 14, wherein the rearward side of the base forms an input for the plurality of optics.

16. The lighting assembly of claim 13, wherein the second lens further comprises:
an input surface longitudinally spaced apart from the first lens at a first focal length to receive the collimated light; and
an output surface to project the received collimated light at a second focal length to form the illumination pattern.

17. The lighting assembly of claim 16, wherein the second lens includes a series of vertically extending segments that extend from the output surface to smooth out the illumination pattern.

18. The lighting assembly of claim 13 wherein the housing comprises a rearward face defining the rearward opening, the lighting assembly further comprising:
a heat sink with a plate having a forward side mounted to the rearward face of the housing and a plurality of fins extending from a rearward side of the plate.

19. A method for illumination, comprising:
receiving input indicative of at least one of an external environment and vehicle controls;
selecting at least one mode based on the input, wherein the at least one mode includes a high-beam mode or a low-beam mode; and
activating at least one of a plurality of light sources in a light assembly to generate light through a plurality of axially aligned collimators, and then through another lens to project the collimated light to generate an illumination pattern based on the selected mode.

20. The method of claim 19 further comprising:
selecting, in addition to the selected high-beam mode or low-beam mode, at least one of a turning mode, a glare-free mode, an object illumination mode, a direction assistance mode, a speed-intensity control mode, an on-road mode, and an off-road mode; and
activating at least one of a plurality of light sources to generate the illumination pattern based on the selected modes.
